(19) United States
(12) Patent Application Publication
(10) Pub. No.: US 2006/0054265 A1
(43) Pub. Date: Mar. 16, 2006

(54) Methods of making laminate products

(76) Inventor: Alan Michael Jaffee, Bowling Green, OH (US)

Correspondence Address: JOHNS MANVILLE;Legal Department, 10100 West Ute Avenue, Littleton, CO, 80127, US

(21) Appl. No.: 10/938,828

(22) Filed: Sep. 10, 2004

(51) Int. Cl. B27N 3/00

(52) U.S. Cl. 156/62.2

(57) ABSTRACT

A method of making a laminate product is provided. The method comprises (a) providing a furnish comprising wood particles and a binder and (b) providing at least one nonwoven fabric mat. A composite mat is formed using the furnish and the nonwoven fabric mat. The composite mat comprises: (1) a mat formed from the furnish, the mat having a first face and a second face, and (2) the nonwoven fabric mat contacting the first face of the mat formed from the furnish. The composite mat is subjected to sufficient heat and pressure to form a laminate product comprising a wood product panel having a first face, a second face, and edges with the nonwoven fabric mat adhered to the first face of the wood product panel.

### BACKGROUND OF THE INVENTION

1. Field of the Invention

The present invention relates to methods of making laminate products comprising a wood product panel with at least one nonwoven fabric mat adhered thereto.

2. Description of the Related Art

It is known to make composite wood product panels from wood particles and binder using elevated heat and pressure. In general, such wood product panels, including oriented strand board (OSB) panels, particle board, chipboard, fiberboard, etc., are produced using particles (e.g., in the form of chips, shavings, fibers, flakes, wafers, strands, etc.) that are mixed with a binder to form a furnish. The furnish is then formed into a mat that is compressed using a heated press or platens to produce a finished article such as a board.

It is also known to make laminates of wood products and fiber glass mats. For example, U.S. Pat. No. 6,331,339 describes methods of making a fiber glass mat especially useful for bonding to wood that contains glass fibers and a “B” staged resin and also describes a method of making wood and wood product laminates using the mat without any other adhesives.

It would be desirable to provide improved methods of making laminates of composite wood panel products and nonwoven fabric mats.

### SUMMARY OF THE INVENTION

In one aspect, a method of making a laminate product is provided. The method comprises (a) providing a furnish comprising wood particles and a binder and (b) providing at least one nonwoven fabric mat. A composite mat is formed using the furnish and the nonwoven fabric mat. The composite mat comprises: (1) a mat formed from the furnish, the mat having a first face and a second face, and (2) the nonwoven fabric mat contacting the first face of the mat formed from the furnish. The composite mat is subjected to sufficient heat and pressure to form a laminate product comprising a wood product panel having a first face, a second face, and edges with the nonwoven fabric mat adhered to the first face of the wood product panel.

In another aspect, a method of making a laminate product is provided. The method comprises (a) providing a furnish comprising wood particles and a binder, and (b) providing at least one nonwoven fabric mat selected from the group consisting of a nonwoven glass fabric mat and a nonwoven polyester fabric mat. A composite mat is formed using the furnish and the nonwoven fabric mat. The composite mat comprises: (1) a multilayer mat formed from the furnish, the multilayer mat having a first face and a second face, the multilayer mat comprising at least one layer having oriented wood particles, and (2) the nonwoven fabric mat contacting the first face of the mat formed from the furnish. The composite mat is subjected to sufficient heat and pressure to form a laminate product comprising a wood product panel having a first face, a second face, and edges with the nonwoven fabric mat adhered to the first face of the wood product panel.

In a further aspect, a method of making a laminate product is provided. The method comprises (a) providing a furnish comprising wood particles and a binder, and (b) providing at least one nonwoven fabric mat, the nonwoven fabric mat being a “B” stage condition nonwoven fabric mat comprising fibers bonded together with a resin binder that is only partially cured. A composite mat is formed using the furnish and the nonwoven fabric mat. The composite mat comprises (1) a multilayer mat formed from the furnish, the multilayer mat having a first face and a second face, the multilayer mat comprising at least one layer having oriented wood particles; and (2) the nonwoven fabric mat contacting the first face of the mat formed from the furnish. The composite mat is then subjected to sufficient heat and pressure to form a laminate product comprising a wood product panel having a first face, a second face, and edges with the nonwoven fabric mat adhered to the first face of the wood product panel.

### BRIEF DESCRIPTION OF THE DRAWINGS

FIG. 1 illustrates the results of testing, for various properties, four types of test boards comprising oriented strand board with different nonwoven fabric mat facings as well as an OSB control as explained below. The test boards were made using a one-step application of heat and pressure.

FIG. 2 illustrates a summary of the test results from FIG. 1.

FIG. 3 illustrates the strength test results for boards comprising OSB with glass mat facings that were made using furfuryl alcohol formaldehyde (FAF) binder with an added water repellant (referred to in the figure as “Enhanced”). The figure also illustrates comparative results for an OSB control (“Control”) that was tested as well as the Canadian Standards Association (CSA) minimum standards (“Standard”) for OSB for each of the tests.

FIG. 4 illustrates the resistance to moisture test results for boards comprising OSB with glass mat facings made using FAF binder and a water repellant (Enhanced). The figure also illustrates comparative results for an OSB control (Control) that was tested as well as the Canadian Standards Association (CSA) minimum standards (Standard) for OSB for each of the tests.

FIG. 5 illustrates strength test results for boards comprising OSB with glass mat facings that were made using phenol formaldehyde (PF) binder (Enhanced). The figure also illustrates the comparative Control and Standard values listed in FIG. 3.

FIG. 6 illustrates the resistance to moisture test results for boards comprising OSB with glass mat facings made using PF binder (Enhanced). The figure also illustrates the comparative Control and Standard values listed in FIG. 4.

FIG. 7 illustrates the strength test results for boards comprising OSB with polyester spunbond mat facings that were made using PF binder (Enhanced). The figure also illustrates the comparative Control and Standard values listed in FIG. 3.

FIG. 8 illustrates the resistance to moisture test results for boards comprising OSB with polyester spunbond mat facings that were made using PF binder (Enhanced). The figure also illustrates the comparative Control and Standard values listed in FIG. 4.

FIG. 9 illustrates the strength test results for boards comprising OSB with a glass mat facings that were made using FAF binder (Enhanced). The figure also illustrates the comparative Control and Standard values listed in FIG. 3.

FIG. 10 illustrates the resistance to moisture test results for boards comprising OSB with glass mat facings made using FAF binder. The figure also illustrates the comparative Control and Standard values listed in FIG. 4.

### DETAILED DESCRIPTION OF THE PREFERRED EMBODIMENTS

The present invention relates to methods of making laminate products comprising a wood product panel with at least one nonwoven fabric mat adhered thereto.

Methods

In general, the methods of making the laminate products comprise attaching at least one nonwoven fabric mat to a face of the wood product panel during manufacture of the wood product panel using a one-step application of heat and pressure (e.g., using a heated press with a pair of plates or a heated mold to apply elevated heat and pressure). The methods involve application of sufficient heat and pressure to a composite mat comprising a preformed wood product panel and at least one nonwoven fabric mat to form a completed laminate product.

The preformed wood product panels comprise wood particles and binder, and may also include other non-wood particles and other additives. The preformed panel is formed by contacting wood particles (and any other particles such as non-wood cellulosic particles or non-cellulosic particles) with a binder (e.g., by mixing, spraying, etc.) to form a mixture or furnish. Any additional additives may also be added with or to the mixture. The amount of binder to be mixed with the wood particles (and any other particles or additives) may vary based upon variables such as the type, size, moisture content, and source of particles used, the binder that is used, and other variables. The furnish (i.e., the mixture of particles, binder, and any other additives) is then formed into a single or multi-layered mat with the particles (or only the wood particles) in the mat (or in individual layers of a multi-layered mat) oriented or non-oriented. The mat may be formed in various ways, and the thickness of the mat may vary.

In order to form a laminate product during manufacture of the wood product panel (rather than after completion of the panel), a composite mat is formed using at least one nonwoven fabric mat and the furnish comprising wood particles and a binder. The composite mat comprises (1) a mat formed from the furnish having a first face and a second face and (2) the nonwoven fabric mat contacting the first face of the mat formed from the furnish. When two nonwoven fabric mats are used with the furnish to form the composite mat, the composite mat may comprise (1) a mat formed from the furnish having a first face and a second face, (2) a first nonwoven fabric mat contacting the first face of the mat formed from the furnish, and (3) a second nonwoven fabric mat contacting the second face of the mat formed from the furnish. The composite mat could be formed by forming the mat from the furnish and then contacting the at least one nonwoven fabric mat to one of the faces of the mat formed from the furnish, or the composite mat could be formed by forming the mat from the furnish while the furnish is in contact with the at least one nonwoven fabric mat such that the nonwoven fabric mat is in contact with a face of the resulting mat formed from the furnish. After being formed, the composite mat is subjected to sufficient heat and pressure to form a laminate product comprising a wood product panel having a first face, a second face, and edges (made from the mat formed from the furnish) and the nonwoven fabric mat or mats adhered to the face or faces of the wood product panel. That is, the composite mat is subjected to sufficient heat and pressure to form the completed/cured wood product panel from the mat formed from the furnish as well as to adhere the nonwoven mat thereto. Thus, only one application of heat and pressure is used, rather than forming the wood product panel using a first application of heat and pressure and then performing a second application of heat and pressure to adhere a nonwoven fabric mat to the panel. The press times, temperatures, and pressures used to form the laminate products may vary depending upon the desired thickness and density of the products, the size and type of particles used in the furnish, the binders that are used composite mat, as well as other variable factors.

The at least one nonwoven fabric mat used in the methods may comprise a “B” staged nonwoven fabric mat or a fully cured nonwoven fabric mat. When a “B” staged nonwoven fabric mat is used in the composite mat, no additional binder or adhesive is typically needed to adhere the nonwoven mat to the wood product panel during the one-step application of heat and pressure (although such additional binder or adhesive may be used if desired); the pressure and heat that the composite mat is subjected to is sufficient to complete the cure of the binder in the “B” staged nonwoven mat and adhere the nonwoven mat to the completed/cured wood product panel.

When a nonwoven fabric mat is used that has been completely cured (i.e., when the nonwoven mat is not in a “B” stage condition), additional binder or adhesive may be used to adhere the nonwoven fabric mat to the wood product panel that is formed during the one-step application of heat and pressure; the pressure and heat that the composite mat is subjected to is sufficient to complete the cure of the additional binder or adhesive and adhere the nonwoven mat to the completed wood product panel. The additional adhesive or binder may be added between the mat formed with the furnish (i.e., the mat comprising wood particles and binder) and the nonwoven fabric mat, may be added to the furnish before forming the mat with the furnish, or may be added to the nonwoven fabric mat.

Methods of making wood product panels such as oriented strand board (OSB), including the equipments used therein, are known. Such methods and equipment may be used in the present methods, with the added step of forming a composite mat suing at least one nonwoven fabric mat as explained above. Methods for making oriented strand boards are described in U.S. patent application Publication No. 2003/0026942, the entire content of which is hereby incorporated herein by reference.

Wood Product Panels

The wood product panels of the laminate products formed by the methods typically have a first face, a second face, and edges, and such panels may be in the form of boards, beams, or other forms and may be flat, nonflat, shaped, etc. As used herein, a “wood product panel” means a panel comprising wood particles bonded together with a binder under heat and pressure.

The wood particles of the panels may be in any form including, but not limited to, chips, shavings, fibers, flakes, wafers, strands, and combinations thereof. The wood particles may be derived from any wood source. In some embodiments, the wood product panels used with the laminate products include only wood particles. In other embodiments, the wood product panels may be constructed of substantially all wood particles, but may also include some non-wood particles. In further embodiments, the wood product panels may be constructed of a majority of wood particles, but may also include a minority of non-wood particles. Non-wood particles that may be included in the wood product panels include non-wood cellulosic particles derived from sources such as, for example, straw, bark, hemp, bagasse, flax, nut shells, etc., and also include non-cellulosic particles such as, for example, particles of glass, mica, rubber, and plastic. The wood product panels may also include other additives including, but not limited to, wax, preservatives, and release agents.

The binder used to bond the wood particles (as well as any other particles) of the panel together may be any binding agent that binds the particles together to form the wood product panel when subjected to heat and pressure. Typical binders for wood product panels include resins such as phenol formaldehyde resin, urea formaldehyde resin, melamine formaldehyde resin, and the like. Other binders that may be used include diisocyanate and polyisocyanate binders such as, for example, diphenyl methane diisocyanate (MDI) binder. Mixtures of different binders may also be used.

Nonwoven Fabric Mats

The nonwoven fabric mats used to form the laminate products comprise fibers bonded together with a binder. In some embodiments, the nonwoven mats may consist of fibers and binder, and in other embodiments the nonwoven mats may include additional additives, such as pigments, dyes, flame retardants, water resistant agents, and/or other additives. Water resistant agents (i.e., water repellants) that may be used include, but are not limited to, stearylated melamine, fluorocarbons, waxes, asphalt, organic silicone, rubber, and polyvinyl chloride.

The fibers of the nonwoven mats may comprise glass fibers, polyester fibers (e.g., polyester spunbonded fibers), polyethylene terathalate (PET) fibers, other types of synthetic fibers (e.g., nylon, polypropylene, etc.), carbon fibers, ceramic fibers, metal fibers, or mixtures thereof. The fibers in the nonwoven mats may consist entirely of one of the previously mentioned types of fibers or may comprise one or more of the previously mentioned types of fibers along with other types of fibers such as, for example, cellulosic fibers or fibers derived from cellulose. The fibers used may be chosen to impart particular characteristics. For example, covering one or both sides with a mat comprised of primarily inorganic fibers enhances fire resistance and reduces flame propagation. The nonwoven mat may also be reinforced within itself or on the surface with parallel strands, diagonal or box shaped reinforcement. These additional reinforcements may comprise glass yarn, filaments of plastic or metal.

The fibers may have various fiber diameters and lengths dependent on the strength and other properties desired in the mat. When polyester fibers are used, it is preferred that the denier of a majority of the fibers is in the range of 3 to 5. When glass fibers are used, it is preferred that a majority of the glass fibers have diameters in the range of 6 to 23 microns, more preferably in the range from 10 to 19 microns, even more preferably in the range of 11 to 16 microns. The glass fibers can be any type of glass including E glass, C glass, T glass, S glass, and other types of glass with good strength and durability in the presence of moisture.

Various binders may be used to bond the fibers together. Typically, binders are chosen that can be put into aqueous solution or emulsion latex and that are water soluble. As explained more fully below, the binders may be completely cured when forming the nonwoven mats or the binders may be “B” staged (i.e., only partially cured). When the binder in a nonwoven mat will be “B” staged, the binders preferably bind well to wood. Examples of binders that may be used for forming nonwoven mats with “B” staged binder include, but are not limited to, a furfuryl alcohol based resin, a phenol formaldehyde resin, a melamine formaldehyde resin, and mixtures thereof. When the mats will be completely formed (i.e., the binder will not be “B” staged), the binders may include, but are not limited to urea formaldehyde, melamine formaldehyde, phenol formaldehyde, acrylics, polyvinyl acetate, epoxy, polyvinyl alcohol, or mixtures thereof. Binders may also be chosen such that the binder is “formaldehyde free”, meaning that the binder contains essentially no formaldehyde (i.e., formaldehyde is not essential, but may be present as an impurity in trace amounts). Binder that may be used to provide formaldehyde free nonwoven mats include, but are not limited to polyvinyl alcohol, carboxy methyl cellulose, lignosulfonates, cellulose gums, or mixtures thereof. The nonwoven mat binder can also include a formaldehyde scavenger, which are known. Using formaldehyde scavengers in the binder dramatically slows the measurable formaldehyde release rate from the product.

Similarly, the nonwoven binder can include antimicrobial additives. Examples of suitable antimicrobial materials include zinc 2-pyrimidinethiol-1-oxide; 1-[2-(3,5-dichloro-phenyl)-4-propyl-[1,3]dioxo-lan-2-ylmethyl]-1H-[1,2,4]triazole; 4,5-dichloro-2-octyl-isothiazolidin-3-one; 2-octyl-isothiazolidin-3-one; 5-chloro-2-(2,4-dichloro-phenoxy)-pheno-1,2-thiazol-4-yl-1H-benzoimidazole; 1-(4-chloro-phenyl)-4,4-dimethyl-3-[1,2,4]triazol-4-ylmethyl-pentan-3-ol; 10,10′oxybisphenoxarsine; 1-(diiodo-methanesulfonyl)-4-methyl-benzene and mixtures thereof. By encapsulating or surface covering the two surfaces of the wood panel with antimicrobial skins the entire product becomes more mold and mildew resistant. The skins can also include an additive such as borates that resist termites or other pests and provides additional fire resistance.

The nonwoven fabric mats may be made with varying ratios of the amount of fiber to the amount of binder in the mat. For example, in the “B” staged mats, it is preferable that the mats contain about 25-75 weight percent fibers and about 15-75 weight percent binder, more preferably 30-60 weight percent fibers and 40-70 weight percent binder. In mats made from formaldehyde free binder, it is preferred that the mats contain about 93-99.5 weight percent fibers and about 0.5-4 weight percent binder. However, other ratios of fiber to binder in the mats may be used for “B” staged mats, formaldehyde free mats, as well as non-“B” staged mats and other mats.

The nonwoven fabric mats may also be made to have varying thicknesses. Typical thicknesses for the mats range from 0.020 inches to 0.125 inches, although thicker and thinner mats may be used.

The nonwoven mats may further include a coating to impart water resistance (or waterproofness), flame resistance, insect resistance, mold resistance, a smooth surface, increased or reduced surface friction, desirable aesthetics, and/or other surface modifications. Coatings that may be used for waterproofing include organic waterproof coatings such as asphalt, organic silicone, rubber, and polyvinyl chloride. The coatings are preferably on the exterior side of the mats (i.e., the side that is not bound to the wood sheet product).

Any method for making nonwoven fabric mats may be used to provide the mats. Processes for making nonwoven fabric mats are well known. U.S. Pat. Nos. 4,112,174, 4,681,802 and 4,810,576, the entire contents of which are hereby incorporated herein by reference, describe methods of making nonwoven glass fabric mats. Methods of making “B” staged nonwoven mats are described in U.S. Pat. Nos. 5,837,620; 6,331,339; and 6,303,207 and U.S. Patent Application Publication No. 2001/0021448, the entire contents of which are incorporated by reference herein. Methods of making nonwoven mats using formaldehyde free binders are described in U.S. Patent Application Publication No. 2003/0008586, the entire content of which is incorporated by reference herein.

One technique for making the nonwoven mats that may be used is forming a dilute aqueous slurry of fibers and depositing the slurry onto an inclined moving screen forming wire to dewater the slurry and form a wet nonwoven fibrous mat, on machines like a Hydroformer™ manufactured by Voith—Sulzer of Appleton, Wis., or a Deltaformer™ manufactured by Valmet/Sandy Hill of Glenns Falls, N.Y. After forming a web from the fibrous slurry, the wet, unbonded mat is transferred to a second moving screen running through a binder application saturating station where the binder in aqueous solution is applied to the mat. The aqueous binder solution is preferably applied using a curtain coater or a dip and squeeze applicator. The excess binder is removed, and the wet mat is transferred to a moving oven belt that runs through a convection oven where the unbonded, wet mat is dried and cured, bonding the fibers together in the mat. The mat may be fully cured or may be cured to only a “B” stage. In the drying and curing oven the mat is heated to temperatures of up to about 350 degrees F., but this can vary from about 210 degrees F. to as high as any temperature that will not deteriorate the binder or, when a “B” stage cure is desired, to as high as any temperature that will not cure the binder beyond “B” stage cure. The treatment time at these temperatures can be for periods usually not exceeding 1 or 2 minutes and frequently less than 40 seconds. When curing the binder to a “B” stage, the lower the temperature that is used for the cure, the longer time required to reach “B” stage cure, although a temperature is normally selected such that the binder will reach “B” stage cure in no more than a few seconds.

The nonwoven fabric mats to be used in the laminate products may be chosen such that they provide added or increased water resistance, mold and mildew resistance, strength (e.g., puncture resistance or flexural strength), dimensional stability, and/or flame resistance of the laminate product as compared to the wood product panels of the laminate products alone. That is, the nonwoven fabric mat(s) may be chosen such that one or more of these properties in the laminate product is greater than that of the wood product panel of the laminate product without the one or more nonwoven fabric mats adhered to the wood product panel.

In addition, the nonwoven fabric mats to be used in the laminate products may also be chosen such that they provide increased strength (e.g., flexural strength), increased dimensional stability, increased water resistance, increased mold resistance, increased flame resistance, and/or reduced weight to the laminate product as compared to a wood product panel of the same type used in the laminate product with comparable dimensions to the completed laminate product (i.e., the same size of the laminate product).

### EXAMPLE

The invention will be further explained by the following illustrative example that is intended to be non-limiting.

Various types of test boards were manufactured using a one-step application of heat and pressure to a composite mat comprising a mat formed from a furnish sandwiched between two nonwoven fabric mats. Briefly, the resulting test boards comprised an oriented strand board with nonwoven fabric mats adhered to both faces of the board. The test boards were tested in order to measure their strength and moisture resistance. Oriented strand board (OSB) without nonwoven fabric mats was used as a control and was tested for the same properties as the test boards.

A. Boards

The following types of boards were tested, with the number of boards manufactured listed in parentheses after the description of the type of board:
(1) OSB with glass mat facings made using furfuryl alcohol formaldehyde (3 boards manufactured);
(2) OSB with glass mat facings made using furfuryl alcohol formaldehyde with stearylated water repellant added to the binder (2 boards manufactured);
(3) OSB with glass mat facings made using phenol formaldehyde binder (2 boards manufactured);
(4) OSB with polyester spunbonded mat facings made using phenol formaldehyde binder (2 boards manufactured); and
(5) OSB with no nonwoven mat facing (i.e., the control) (2 boards manufactured).

The “B” staged nonwoven mats used for the boards were formed using a conventional wet lay process. The basis weight of the glass mats used with the test samples was 6 lbs./100 ft.², with the mats made with approximately 60% binder and 40% fibers. The glass fibers used in the glass mats were E glass fibers having average fiber diameters of 16 microns and an average length of 1 inch. In the glass mats with stearylated water repellant added to the binder, the mats were made with approximately 40% fibers, 56% binder, and 4% water repellant. The basis weight of the polyester spunbonded mats were 120 g/m², with the phenol formaldehyde binder applied at 3 lbs./100 ft². The polyester spunbond fiber used in the mats had a denier of approximately 4 dpf.

The test boards and the oriented strand board control boards were prepared using a 34″×34″ forming box. To form the OSB control boards, the furnish of wood strands and binder was hand formed into mats using the forming box. To form the test laminate boards, the furnish of wood strands and binder and the “B” staged nonwoven mats were hand formed into composite mats using the forming box. The hand formed mats were then pressed using a typical OSB press cycle. All parameters were based on typical OSB commercial values as summarized in the table below.

| | |
|---|---|
| Target Dimensions (inches) | 28 × 28 × 0.437 |
| Target Density (lbs./ft.³) | 39.0 |
| Mat Construction | Oriented Face/core ratio - 50/50 |
| Resin Type | Face: Liquid Phenol Formaldehyde |
| | Core: Isocyanate resin (MDI) |
| Wax Type | Slack Wax 1% solids |
| Press Temperature | 400 |
| (degrees Fahrenheit) | |

The panels were pressed to the target thickness of 0.437″. The panels were pressed for approximately 150 seconds at a press temperature of 400° F. The resulting boards were trimmed to approximately 28″×28″.

B. Measurements

Each type of test board and the control boards were measured for the following properties in order to assess strength and moisture resistance, with the number of samples per board that were tested listed in parentheses after the description of the test:
(1) modulus of rupture (MOR) in the parallel direction of the OSB (MOR para), measured in pounds per square inch (psi) (3 samples per board tested);
(2) modulus of rupture in the perpendicular direction of the OSB (MOR perp), measured in psi (3 samples per board tested);
(3) modulus of elasticity (MOE) in the parallel direction of the OSB (MOE para), measured in psi (3 samples per board tested);
(4) modulus of elasticity in the perpendicular direction of the OSB (MOE perp), measured in psi (3 samples per board tested);
(5) internal bond, measured in psi (6 samples per board tested);
(6) bond durability in the parallel direction of the OSB measured as the modulus of rupture after 2 hours of boiling a sample of a board, measured in psi (3 samples per board tested);
(7) bond durability in the perpendicular direction of the OSB measured as the modulus of rupture after 2 hours of boiling a sample of a board, measured in psi (3 samples per board tested);
(8) thickness swell percentage after 24 hours of soaking a sample of a board in water (2 samples per board tested);
(9) water absorption after 24 hours of soaking a sample of a board in water, measured as percentage (2 samples per board tested);
(10) linear expansion in the parallel direction of the OSB from oven dry to saturated using a vacuum pressure soak, measured as percentage (2 samples per board tested);
(11) linear expansion in the perpendicular direction of the OSB from oven dry to saturated using a vacuum pressure soak, measured as percentage (2 samples per board tested); and
(12) water vapor transmission, measured in perms (2 samples per board tested).

Each of properties (1)-(1 1) listed above was evaluated using Canadian Standards Association (CSA) test standard 0437.1-93. Water vapor transmission (i.e., property (12) above) was measured using ASTM Standard Test Method E96.

C. Results

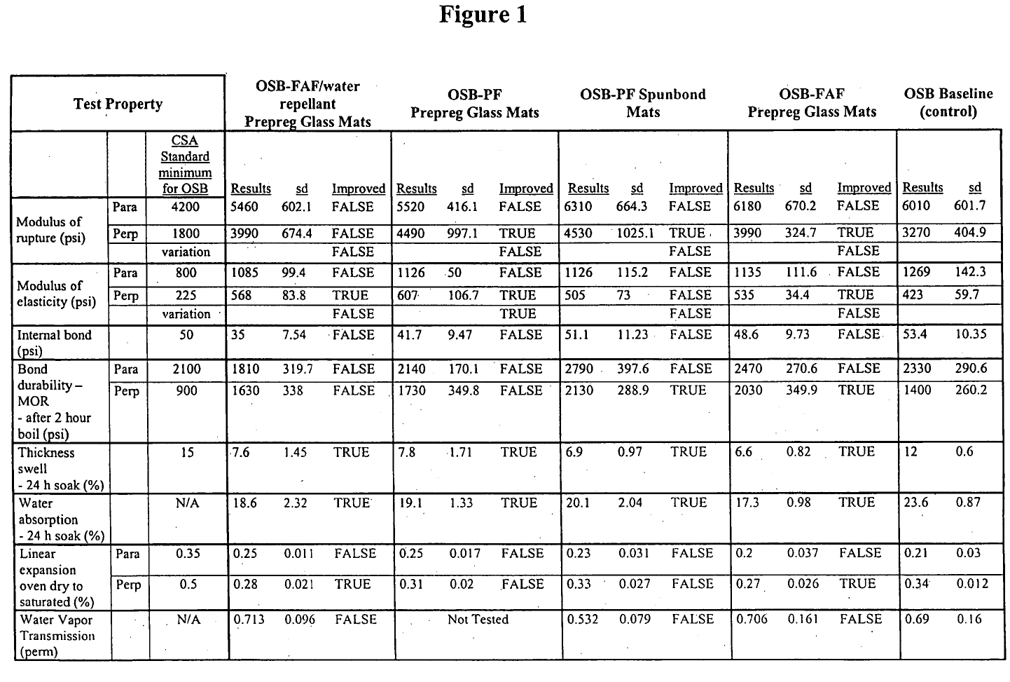

The results of the measurements of the properties of the various boards are shown in FIG. 1. FIG. 1 lists the results of the tests, the standard deviation (sd) of the tests, and an indication of whether the results for each type of board were improved versus the control sample (i.e., OSB Baseline) at a statistically significant level (i.e., a 95% confidence level) using the Student's T-test (indications were given as True or False). FIG. 1 also includes an indication for the modulus of rupture (MOR) and the modulus of elasticity (MOE) tests of whether the reduction in variation between the results for each type of board and the variation of the results for the control sample boards (i.e., OSB Baseline) for these tests were statistically significant with 95% confidence level using a Chi-Square test (indications were given as True or False, with True being an indication that the variation in the test results were reduced at a statistically significant level as compared to the variation in the OSB control boards). Finally, FIG. 1 also lists for some of the tests the CSA standard minimum for OSB.

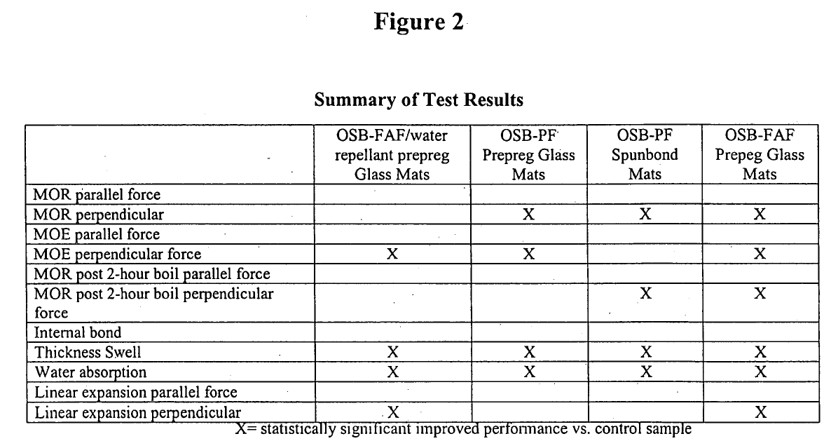

The results illustrate increased strength and moisture resistance in the test boards. FIG. 2 summarizes the results showing the statistically significant improvements that were made to the perpendicular force strength and water resistance in the test boards versus the OSB control boards.

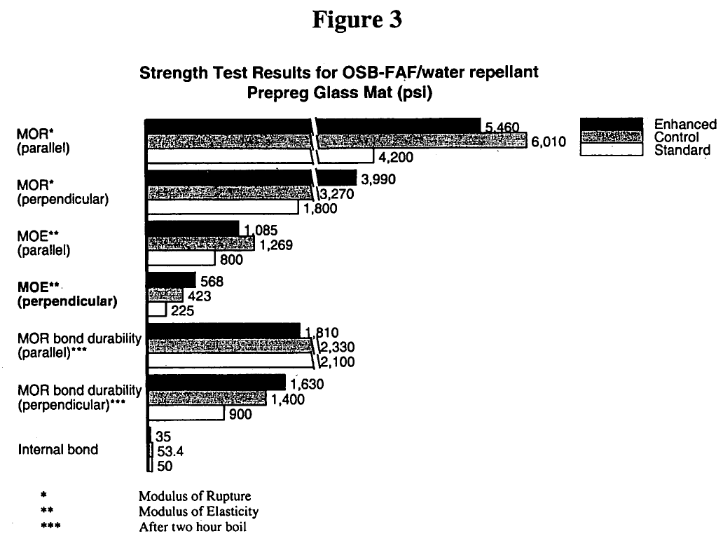

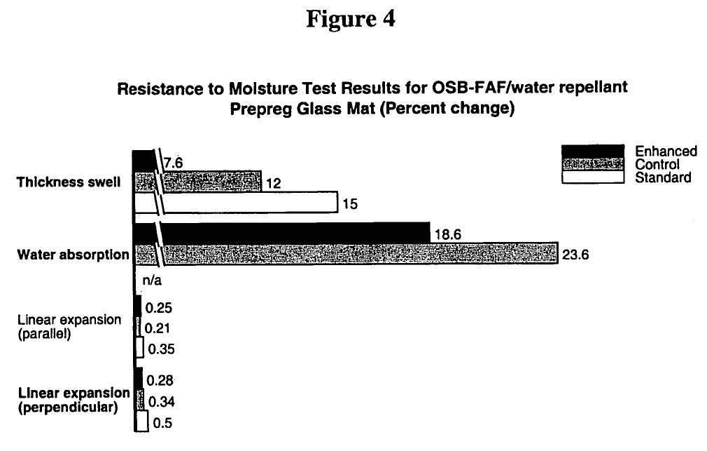

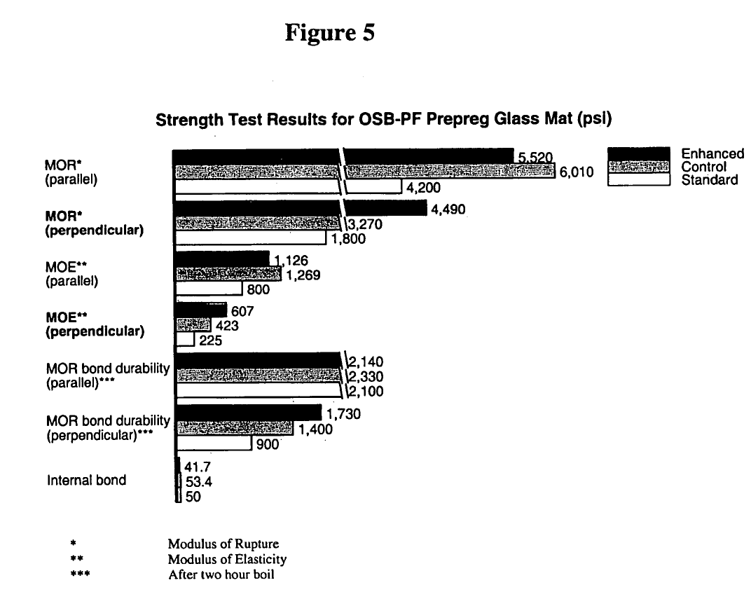

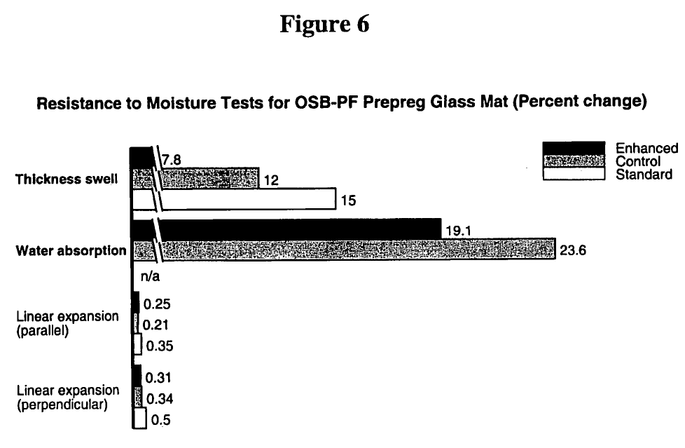

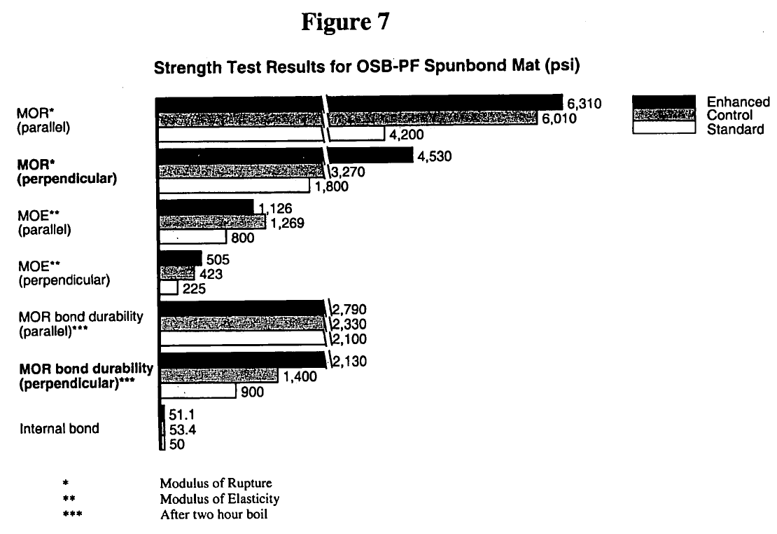

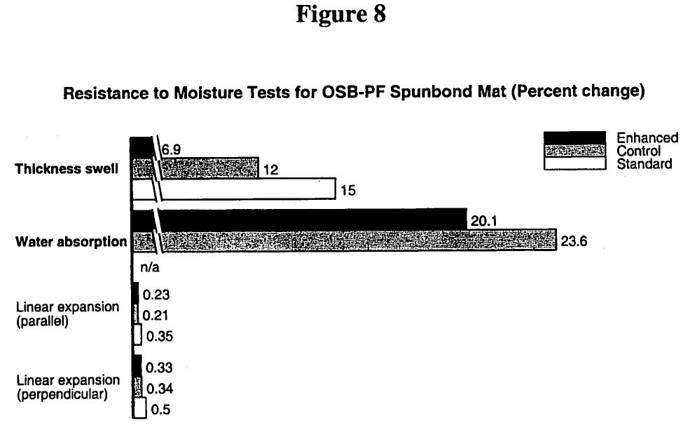

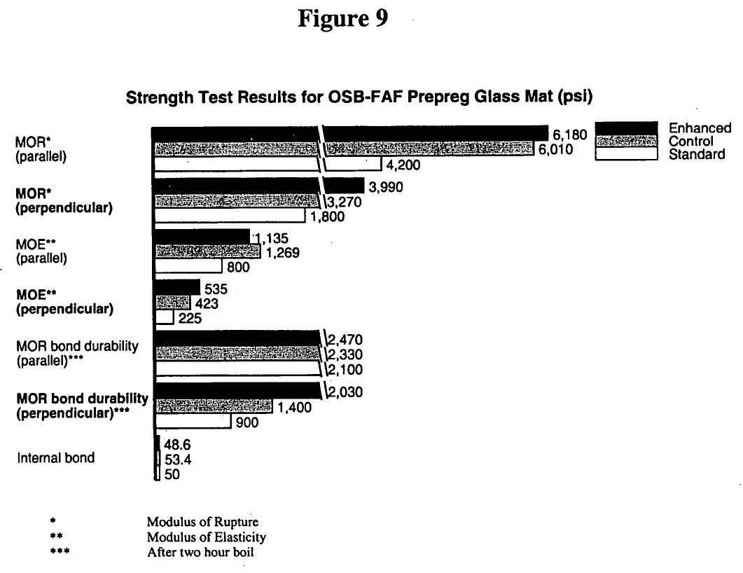

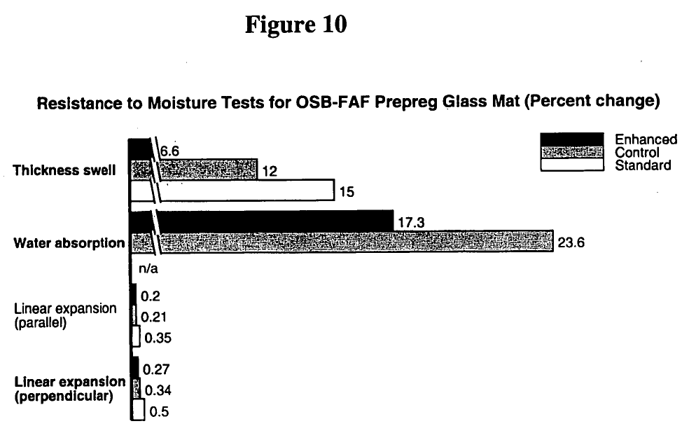

FIGS. 3-10 illustrate the strength and resistance to moisture test results for the test boards. The test descriptions listed in bold type indicate those tests where the listed test boards had a statistically significant difference from the control boards at the 95% confidence level.

While the invention has been described in detail and with reference to specific embodiments thereof, it will be apparent to one skilled in the art that various changes and modifications can be made without departing from the spirit and scope of the invention.

What is claimed is:

1. A method of making a laminate product comprising the steps of:
(a) providing a furnish comprising wood particles and a binder;
(b) providing at least one nonwoven fabric mat;
(c) forming a composite mat using the furnish and the nonwoven fabric mat, the composite mat comprising:
(1) a mat formed from the furnish, the mat having a first face and a second face; and
(2) the nonwoven fabric mat contacting the first face of the mat formed from the furnish; and
(d) subjecting the composite mat to sufficient heat and pressure to form a laminate product comprising a wood product panel having a first face, a second face, and edges with the nonwoven fabric mat adhered to the first face of the wood product panel.

2. The method of claim 1, wherein the composite mat further comprises a second nonwoven fabric mat contacting the second face of the mat formed from the furnish and step (d) results in a laminate product comprising the wood product panel with the nonwoven fabric mat adhered to the first face of the panel and the second nonwoven mat adhered to the second face of the panel.

3. The method of claim 1, wherein the nonwoven fabric mat is selected from the group consisting of a glass fiber nonwoven mat and a polyester fiber nonwoven mat.

4. The method of claim 1, wherein the binder is selected from the group consisting of phenol formaldehyde resin, urea formaldehyde resin, melamine formaldehyde resin, diisocyanate binder, polyisocyanate binder, and mixtures thereof.

5. The method of claim 1, wherein the nonwoven fabric mat comprises a fungicide, pesticide, fire retardant or mixture thereof.

6. The method of claim 1, wherein the nonwoven fabric mat is a “B” stage condition nonwoven fabric mat comprising fibers bonded together with a resin binder that is only partially cured.

7. The method of claim 1, wherein the mat comprises fibers bonded together with a formaldehyde free binder.

8. The method of claim 1, wherein the mat is formed from the furnish is a multilayer mat, the multilayer mat comprising at least one layer having oriented wood particles.

9. The method of claim 1, wherein the wood product panel is oriented strand board.

10. A method of making a laminate product comprising the steps of:
(a) providing a furnish comprising wood particles and a binder;
(b) providing at least one nonwoven fabric mat selected from the group consisting of a nonwoven glass fabric mat and a nonwoven polyester fabric mat;
(c) forming a composite mat using the furnish and the nonwoven fabric mat, the composite mat comprising:
(1) a multilayer mat formed from the furnish, the multilayer mat having a first face and a second face, the multilayer mat comprising at least one layer having oriented wood particles; and
(2) the nonwoven fabric mat contacting the first face of the mat formed from the furnish; and
(d) subjecting the composite mat to sufficient heat and pressure to form a laminate product comprising a wood product panel having a first face, a second face, and edges with the nonwoven fabric mat adhered to the first face of the wood product panel.

11. The method of claim 10, wherein the wood product panel of the laminate product formed in step (d) is oriented strand board.

12. The method of claim 10, wherein the composite mat further comprises a second nonwoven fabric mat contacting the second face of the mat formed from the furnish and step (d) results in a laminate product comprising the wood product panel with the nonwoven fabric mat adhered to the first face of the panel and the second nonwoven mat adhered to the second face of the panel

13. A method of making a laminate product comprising the steps of:
(a) providing a furnish comprising wood particles and a binder,
(b) providing at least one nonwoven fabric mat, the nonwoven fabric mat being a “B” stage condition nonwoven fabric mat comprising fibers bonded together with a resin binder that is only partially cured;
(c) forming a composite mat using the furnish and the nonwoven fabric mat, the composite mat comprising:
(1) a multilayer mat formed from the furnish, the multilayer mat having a first face and a second face, the multilayer mat comprising at least one layer having oriented wood particles; and
(2) the nonwoven fabric mat contacting the first face of the mat formed from the furnish; and
(d) subjecting the composite mat to sufficient heat and pressure to form a laminate product comprising a wood product panel having a first face, a second face, and edges with the nonwoven fabric mat adhered to the first face of the wood product panel.

14. The method of claim 13, wherein the wood product panel of the laminate product formed in step (d) is oriented strand board.

15. The method of claim 14, wherein the nonwoven fabric mat is selected from the group consisting of a glass fiber nonwoven mat and a polyester fiber nonwoven mat.

16. The method of claim 15, wherein the composite mat further comprises a second nonwoven fabric mat contacting the second face of the mat formed from the furnish and step (d) results in a laminate product comprising the wood product panel with the nonwoven fabric mat adhered to the first face of the panel and the second nonwoven mat adhered to the second face of the panel.
